(19) United States
(12) Patent Application Publication
(10) Pub. No.: US 2008/0240054 A1
(43) Pub. Date: Oct. 2, 2008

(54) Relay scheduling in wireless networks

(76) Inventors: Sumeet Sandhu, Santa Clara, CA (US); Chris Knudsen, Beaverton, OR (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/731,038

(22) Filed: Mar. 30, 2007

(51) Int. Cl. H04Q 7/24

(52) U.S. Cl. 370/338

(57) ABSTRACT

Methods, apparatuses and systems for communicating in a wireless network are disclosed. One embodiment includes a method for communication in a wireless network that comprises scheduling relay transmissions by stations in separate cells of the wireless network based on out-of-cell interference. The method may also include transmitting data by one or more wireless nodes within the wireless network using orthogonal downlink frame formats and uplink frame formats that prevent a first station of a particular class from transmitting while a separate, second station of the particular class is listening. Other embodiments are disclosed and claimed.

### FIELD

Embodiments are in the field of wireless communications. More particularly, embodiments are in the field of multi-hop wireless relay networks.

### BRIEF DESCRIPTION OF THE DRAWINGS

Aspects of embodiments of the invention will become apparent upon reading the following detailed description and upon reference to the accompanying drawings in which like references may indicate similar elements:

FIG. 1 depicts a block diagram illustrating an arrangement of wireless nodes in a wireless network including multiple base stations and relay stations according to various embodiments;

FIG. 2 depicts a block diagram illustrating an arrangement of wireless nodes in a multi-cellular wireless network with scheduled relays according to various embodiments;

FIG. 3A depicts a block diagram illustrating a downlink frame format according to various embodiments;

FIG. 3B depicts a block diagram illustrating an uplink frame format according to various embodiments;

FIG. 4A depicts a block diagram illustrating a downlink frame format for a plurality of relay stations in a first cell according to various embodiments;

FIG. 4B depicts a block diagram illustrating a downlink frame format for a plurality of relay stations in a second cell according to various embodiments;

FIG. 5 depicts a flow diagram illustrating a method for determining inter-cell relay scheduling and transmitting data according to various embodiments; and

FIG. 6 depicts a block diagram showing an example wireless apparatus according to various embodiments.

### DETAILED DESCRIPTION OF EMBODIMENTS

The following is a detailed description of embodiments of the invention depicted in the accompanying drawings. The embodiments are introduced in such detail as to clearly communicate the invention. However, the embodiment(s) presented herein are merely illustrative, and are not intended to limit the anticipated variations of such embodiments; on the contrary, the intention is to cover all modifications, equivalents, and alternatives falling within the spirit and scope of the appended claims. The detailed descriptions below are designed to make such embodiments obvious to those of ordinary skill in the art.

It is becoming increasingly attractive to use nodes in a wireless network as relaying points to extend range and/or reduce costs of the wireless network. For example, in a wireless wide area network (WWAN) or wireless metropolitan area network (WMAN) that requires deployment of distributed base stations across large areas, the base stations need to be connected to a core network and/or each other via some type of backhaul. In conventional networks, the backhaul has typically consisted of wired connections. However, a wireless backhaul, rather than, or in some combination with, a wired backhaul is being increasingly considered to ease deployment and reduce costs associated with these networks.

A type of network which uses wireless stations to relay signals between a source and destination are colloquially referred to as mesh networks. In mesh networks, wireless network nodes may form a “mesh” of paths which a communication may travel to reach its destination. The use of a wireless mesh network as a wireless backhaul has become the subject of much focus and there are ongoing efforts to increase the efficiency of transmissions through wireless mesh networks.

While the following detailed description may describe example embodiments of the present invention in relation to wireless metropolitan area networks (WMANs) or other wireless wide area networks (WWANs), the inventive embodiments are not limited thereto and can be applied to other types of wireless networks where similar advantages may be obtained. Such networks for which inventive embodiments may be applicable specifically include, wireless personal area networks (WPANs), wireless local area networks (WLANs), WWANs such as cellular networks and/or combinations of any of these networks. Further, inventive embodiments may be discussed in reference to wireless networks utilizing Orthogonal Frequency Division Multiplexing (OFDM) modulation. However, the embodiments of present invention are not limited thereto and, for example, can be implemented using other modulation and/or coding schemes where suitably applicable.

The following inventive embodiments may be used in a variety of applications including transmitters and receivers of a radio system. Radio systems specifically included within the scope of the present invention include, but are not limited to, network interface cards (NICs), network adaptors, mobile stations, base stations, access points (APs), hybrid coordinators (HCs), gateways, bridges, hubs, routers, relay stations, repeaters, analog repeaters, and amplify and forward repeaters. Further, the radio systems within the scope of the invention may include cellular radiotelephone systems, satellite systems, personal communication systems (PCS), two-way radio systems and two-way pagers as well as computing devices including radio systems such as personal computers (PCs) and related peripherals, personal digital assistants (PDAs), personal computing accessories and all existing and future arising systems which may be related in nature and to which the principles of the inventive embodiments could be suitably applied.

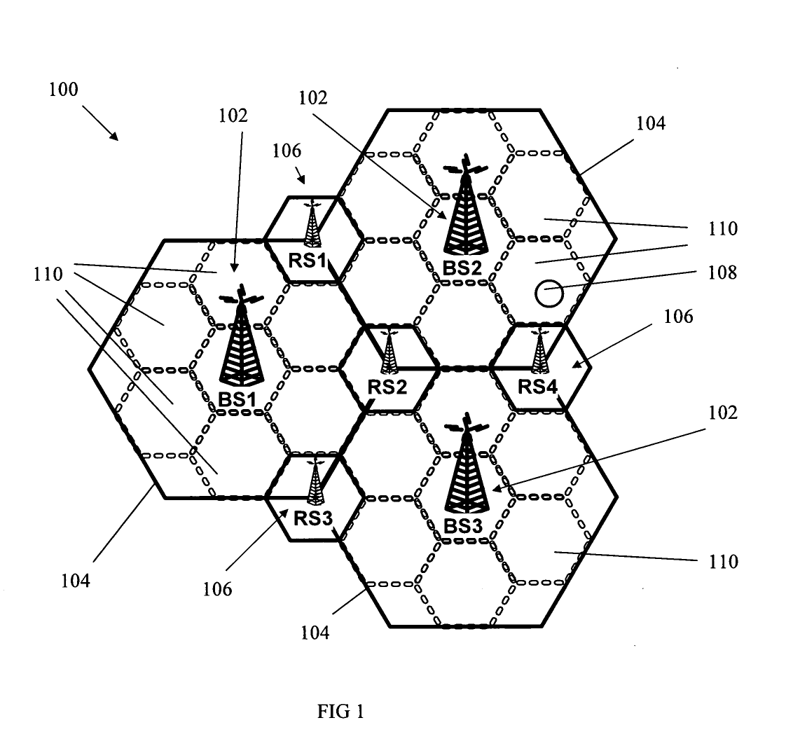

FIG. 1 depicts a block diagram illustrating an arrangement of wireless nodes in a wireless network including multiple base stations and relay stations according to various embodiments. A wireless network 100 (which may also be known as a mesh network 100) according to various inventive embodiments may be any system having devices capable of transmitting and/or receiving information via over-the-air (OTA) radio frequency (RF) links. In the depicted embodiment, wireless network 100 may include a plurality of cells 104 each comprised of a plurality of wireless nodes 110 to communicate or relay messages to and/or from one or more fixed or mobile devices, such as a mobile station 108 or subscriber station (mobile station 108 will be used herein for both). Wireless network 100 may be considered a multi-hop relay network that facilitates communication across multiple nodes 110 and cells 104. Nodes 110 may include base stations 102 or relay stations 106. In the depicted embodiment, each base station 102 serves as a center for a cell 104 and the relay stations 106 are positioned at cell edge between the various base stations 102. It should be recognized that FIG. 1 represents an example cell topology where each node 110 would be located at a center of each illustrated hexagon. Each hexagon in the illustrated pattern is intended to generally represent a spatial or “cellular” range for radio link coverage of each node 110 in a region of nodes 110 that form wireless network 100.

In certain embodiments, the wireless nodes 110 in wireless network 100 may be devices which communicate using wireless protocols and/or techniques compatible with one or more of the Institute of Electrical and Electronics Engineers (IEEE) various 802 wireless standards including for example, 802.11 (a), (b), (g) and/or (n) standards for WLANs, 802.15 standards for WPANs, 802.16 standards for WMANs, 3G, 3GPP2, 3G LTE, and/or 4G, although the inventive embodiments are not limited in this respect. In an exemplary embodiment, the wireless nodes 110 communicate using wireless protocols and/or techniques compatible with the IEEE 802.16j Mobile Multi-hop Relay Task Group for communication in WMANs. Base stations 102 and relay stations 106 may typically have such capabilities as performing association, authentication, time/frequency resource allocation, or other tasks.

In certain non-limiting example implementations of the inventive embodiments, one or more of nodes 110 (e.g., base stations 102) in wireless network 100 may be a wireless transceiver that is connected to a core network, such as an Internet protocol (IP) network, via a physical wired connection (e.g., electrical or fiber optic connection). These types of stations are referred to herein as base station (BS) 102 nodes. Additionally, in certain embodiments, one or more of nodes (e.g., relay stations 106) in network 100 may be wireless transceivers that are not connected to a core network by electrical or wires or optical cables but rather are connected to the core network via a wireless backhaul to the base station as mentioned previously. These types of stations may be fixed radio relay nodes which are sometimes referred to as “micro” or “pico” base stations (depending on the size of their coverage area) or relay stations, although the inventive embodiments are not limited in this respect. Hereinafter, these types of unwired relay nodes are generically referred to as relay station 106 nodes. In a typical arrangement, relay stations 106 are not directly connected to a wire infrastructure and have the minimum functionality to support multi-hop communication.

According to the various embodiments herein, the wireless nodes 110 in wireless network 100 may be configured to communicate using orthogonal frequency division multiple access (OFDMA) protocols. OFDMA is also referred to as multi-user orthogonal frequency division multiplexing (OFDM). In OFDM, a single transmitter transmits a carrier comprised of many different orthogonal (independent) frequencies (called subcarriers or tones) which may each be independently modulated according to a desired modulation scheme (e.g., quadrature amplitude modulation (QAM) or phase-shift keying (PSK)). OFDMA is adapted for multiple users generally by assigning subsets of subcarriers and/or time slots within subcarriers to individual users or nodes in the network. There are various types of OFDM and/or OFDMA schemes, e.g., scalable OFDMA and/or flash OFDMA, which may be utilized by the inventive embodiments as suitably desired. One of ordinary skill in the art will recognize that the wireless nodes 110 in wireless network 100 may communicate using other types of protocols in other embodiments.

Typically, the transmit power and antenna heights of the wireless transceivers in relay stations 106 are less than those for base stations 102, while those for mobile stations 108 are typically even less. Further, multi-hop wireless network 100 may be comprised of several macro cells 104, each of which may generally comprise at least one macro base station similar to station 102 and a plurality of relay stations 106 dispersed throughout the macro cell and working in combination with the base station(s) 102 to provide a full range of coverage to mobile stations 108 which may be present within the range of the cell 104. In certain embodiments of wireless network 100, relay stations 106 may facilitate connectivity to each other and/or to base stations 102 via wireless links using protocols compatible with one or more of the IEEE various 802.16 and/or 802.11 standards, although the inventive embodiments are not limited in this respect.

The distribution of relay stations 106 and base stations 102 throughout wireless network 100 and the different heights of each may result in interference across cells 104. Such an increase in interference may result in reductions or elimination of the performance gains resulting from multi-hop relaying. Relay stations 106 may interfere with other relay stations 106 and/or base stations 102 located in a different cell 104 and thus cause these performance drops. An example of typical heights for components of the wireless network 100 will illustrate the potential interference inherent in existing systems.

Assuming a typical height of two (2) meters for the mobile station 108, 12 meters for a relay station 106, and 30 meters for a base station 102, the predicted path loss between channels may be determined. Channel models currently proposed for IEEE 802.16j specify a path loss exponent of 2 (i.e., relative free space) for a base station-base station channel, a path loss exponent of 3 for base station-relay station and relay station-relay station channels, and a path loss exponent of 4 (i.e., for lossy or cluttered environments) for base station-mobile station and relay station-mobile station channels. Received signal power relates to distance as a function of the path loss exponent. Accordingly, channels with a lower path loss exponent will allow signals to travel further than channels with high path loss exponents. Using the example heights above, the signal from a base station 102 to a mobile station 108 will attenuate by 120 dB at a cell edge radius of one kilometer while the same signal directed to another base station 102 will attenuate the same amount at nine kilometers. Shadowing and fading will likely modify these results but the average trends may be accurately predicted by path loss.

The disclosed embodiments consider the interference caused by a relay station 106 to other relay stations 106 and/or base stations 102 in determining how to schedule transmissions of the relay station 106. The interference caused by a relay station 106 is caused when some relay stations 106 are receiving while others are transmitting, even if they are in different cells 104. Placement of a relay station 106 within a cell 104 may also impact the existence and amount of interference but is beyond the scope of this application.

As will be described in more detail subsequently, the disclosed system eliminates interference caused by a relay station 106 by utilizing orthogonal uplink and downlink frame formats for scheduling of base station 102, relay station 106, and mobile station 108 transmissions to avoid interference. Interference is avoided by ensuring through the use of uplink and downlink frame formats that different stations of the same class are not simultaneously transmitting and listening. To avoid interference, for example, no relay stations 106 will be listening while other relay stations 106 are transmitting. The disclosed system may also use multi-cellular relay scheduling to minimize out-of-cell interference, as will be described in more detail in relation to FIG. 2. This system may thus provide a competitive architecture for IEEE 802.16j or other networks that avoids the pitfalls of relay self-interference that has been observed in the field.

FIG. 2 depicts a block diagram illustrating an arrangement of wireless nodes in a multi-cellular wireless network with scheduled relays according to various embodiments. The wireless network 100 of FIG. 2 is an alternative embodiment to that of FIG. 1 and more clearly illustrates the scheduled relays across multiple cells 104, and description of components of wireless network 100 will not be repeated in the interest of brevity. The wireless network 100 of FIG. 2 depicts two cells 104 on the same frequency served by two separate base stations 102 (BS1 on the left as depicted, BS2 on the right). Additional unreferenced cells 104 also include nodes of wireless network 100 which may not be relevant to the specific example.

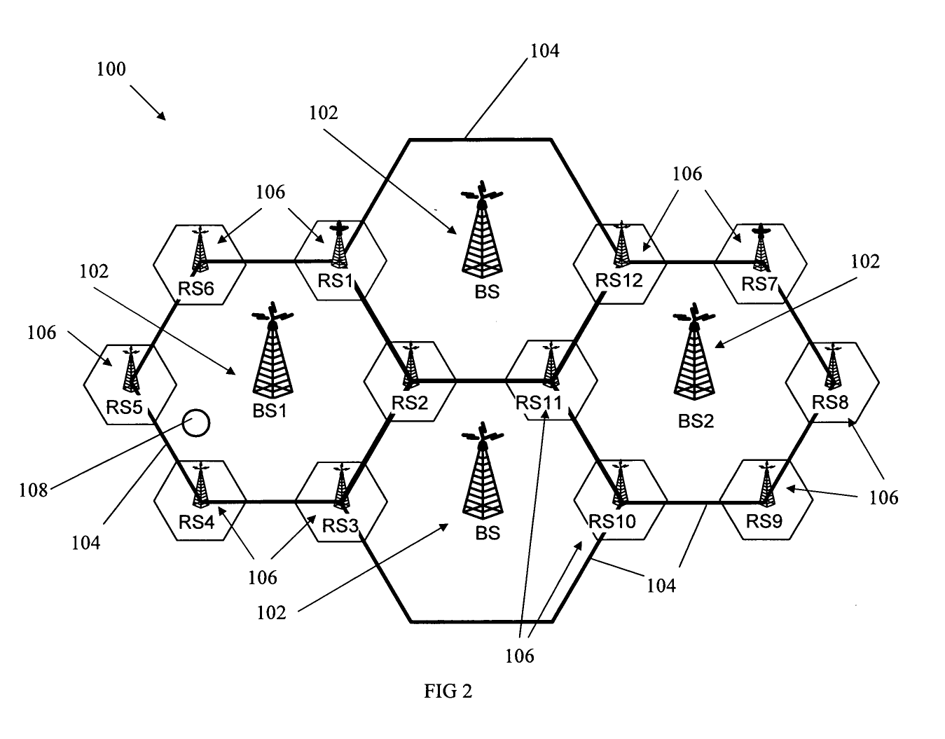

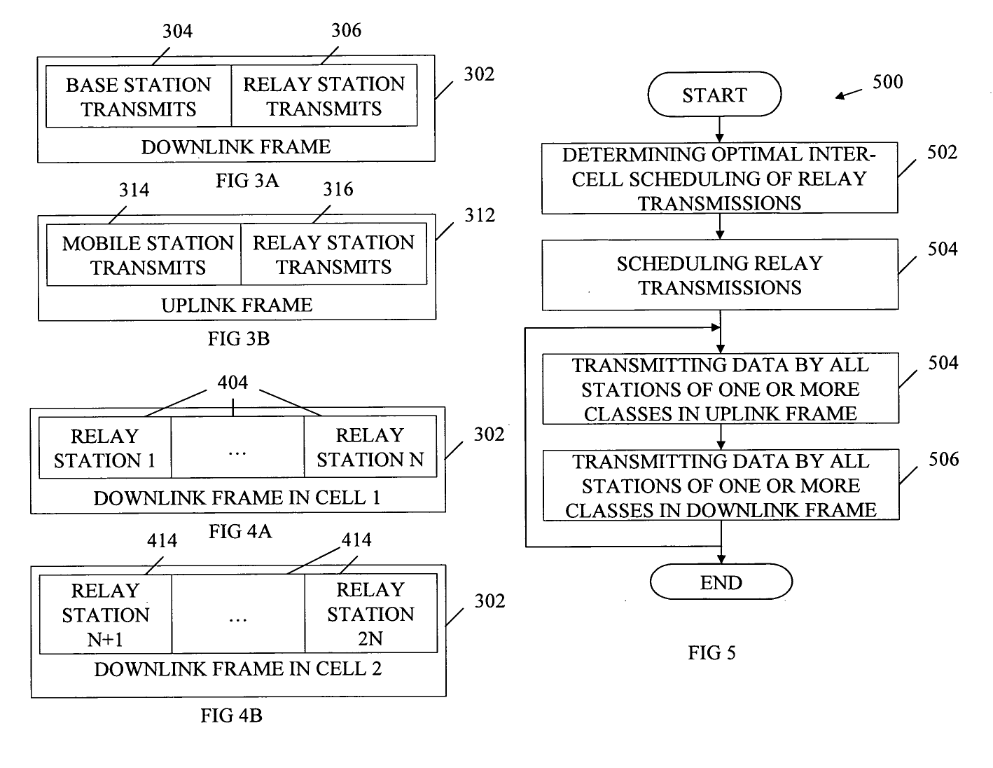

By utilizing the orthogonal frame formats described in relation to FIGS. 3A, 3B, 4A, and 4B, the wireless network 100 may provide synchronization among multiple cells 104 to ensure that all base stations 102 transmit together, that all relay stations 106 transmit together, and that all mobile stations 108 or other subscriber stations transmit together. This synchronization helps ensure that there is no situation where some stations of the same class (whether the class is base stations 102, relay stations 106, or mobile stations 108) are listening while others of the same class are transmitting.

In the wireless network 100 of FIG. 2, base station 1 (BS1) controls relay stations 1-6 (RS1-RS6) while base station 2 (BS2) controls relay stations 7-12 (RS7-RS12). In some embodiments, inter-cell scheduling of relay stations 106 is configured so that relay stations 106 in roughly the same topological area with respect to their base station 102 transmit simultaneously. In the depicted example, RS1 and RS7 would transmit together, RS2 and RS8 would transmit together, RS4 and RS10 would transmit together, and so forth. In these embodiments, for example, RS1 and RS7 are associated with each other by being in roughly the same position (upper right as depicted) with respect to their base stations 102. This facilitates a form of spatial reuse for relay stations 106 such that mobile stations 108 in all relay footprints experience uniform interference levels from other relays.

In an actual deployment, relay stations 106 are not likely to be placed in such regular patterns as depicted in FIG. 2 and, even if they were, real world conditions such as shadowing and fading become significant issues in relay design, particularly for small cells 104. For more problematic designs, each base station 102 may optionally dynamically schedule its relay stations 106 based on measured SIR patterns rather than topology. In alternative embodiments, each base station 102 may utilize a combination of topology and measured SIR patterns to determine its pattern of relay stations 106.

FIGS. 3A and 3B depict block diagrams illustrating frame formats according to various embodiments. FIG. 3A depicts a block diagram illustrating a downlink frame format while FIG. 3B depicts a block diagram illustrating an uplink frame format. Downlink frame 302 of the depicted embodiment includes a base station transmission sub-signal 304 and a relay station transmission sub-signal 306. Uplink frame 312 of the depicted embodiment includes a mobile station transmission sub-signal 314 and a relay station transmission sub-signal 316. As described previously, the downlink frame 302 and the uplink frame 312 are orthogonal to each other so that they may exist in parallel in a high speed signal. By providing for orthogonal uplink frames 312 and downlink frames 302 that require stations of the same class to transmit while no others of the same class are listening, the disclosed formats avoid or reduce interference between different components of wireless network 100.

FIGS. 4A and 4B depict block diagrams illustrating frame formats according to various embodiments. FIG. 4A depicts a block diagram illustrating a downlink frame 302 format for a plurality of relay stations in a first cell while FIG. 4B depicts a block diagram illustrating a downlink frame 302 format for a plurality of relay stations in a second cell. Downlink frame 302 of FIG. 4A depicts the relay station transmission sub-signal 306 of FIG. 3A being divided into further relay station sub-signals 404 for each relay station 106 in a particular cell 104. Similarly, downlink frame 302 of FIG. 4B depicts the relay station transmission sub-signal 306 of FIG. 3A being divided into further relay station sub-signals 414 for each relay station 106 in a second cell 104. Relay station sub-signals 404 for the first cell and relay station sub-signals 414 for the second cell may be matched so that the determined relay scheduling between the cells 104 occurs. This helps ensure a form of spatial reuse for relay stations 106 such that mobile stations 108 in either cell 104 experience uniform interference levels from other relay stations 106.

Applying the downlink frames 302 of FIGS. 4A and 4B to the example wireless network 100 of FIG. 2, RS1 in the first cell would transmit simultaneously with RS7 (N=6 as there are six relay stations 106 in each cell, and N+1=7) in the second cell. Similarly, RS2 would transmit simultaneously with RS8 (6+2), RS3 would transmit simultaneously with RS9 (6+3), and so on. By separating particular relay stations 106 within the downlink frame format, a reduced level of interference caused by other relay stations 106 can be achieved.

FIG. 5 depicts a flow diagram illustrating a method for determining inter-cell relay scheduling and transmitting data according to various embodiments. Some or all of the elements of method 500 may be performed by components of the wireless network 100, such as a base station 102 or relay station 106. Method 500 begins with optional element 502, determining an optimal inter-cell scheduling of relay transmissions. A base station 102 or other device (such as a central base station controller) may determine an optimal inter-cell scheduling of relay transmission by estimating SIR patterns based on the use of topology of the relay stations 106, the physical geography or other conditions of the area, or other methodology. For example, a base station 102 may schedule topologically-similar relay stations 106 to transmit simultaneously. Alternatively, a base station 102 or other device may measure SIR patterns during usage and use such measured patterns to determine an optimal inter-cell scheduling of relay transmissions. For example, a base station 102 may schedule relay stations 106 with similar SIR patterns to transmit simultaneously. Such measurement and determination may be performed dynamically in some embodiments so that real world conditions can be accommodated in the relay scheduling.

The base station 102 or other device may then schedule the relay transmission based on out-of-cell interference at element 504. The base station 102 may perform this task based on the determined inter-cell scheduling of element 502, if performed. By associating relay stations 106 from different cells 104 (and thus base stations 102) based on estimated or determined SIR patterns (that is, out-of-cell interference), interference between relay stations 106 may be substantially reduced. The base station 102 may also at element 504 transmit the determined scheduling information to relay stations 106, mobile stations 108, and/or other base stations 102 at element 504 as required.

At elements 504 and 506, a component of the wireless network 100 may transmit date by all stations of one or more classes in an uplink frame as well as in an orthogonal downlink frame, after which the method may terminate or return for additional processing and transmissions. Data may be transmitted by a wireless node 110 (such as a base station 102 or relay station 106) within the wireless network 100 using orthogonal downlink and uplink frame formats. The orthogonal downlink and uplink frame formats prevent a first station of a particular class from transmitting while a second, separate station of the same particular class is listening. As described previously, some embodiments of the downlink frame format may include base station transmissions and relay station transmissions while the uplink frame format may include relay station transmissions and mobile station transmissions.

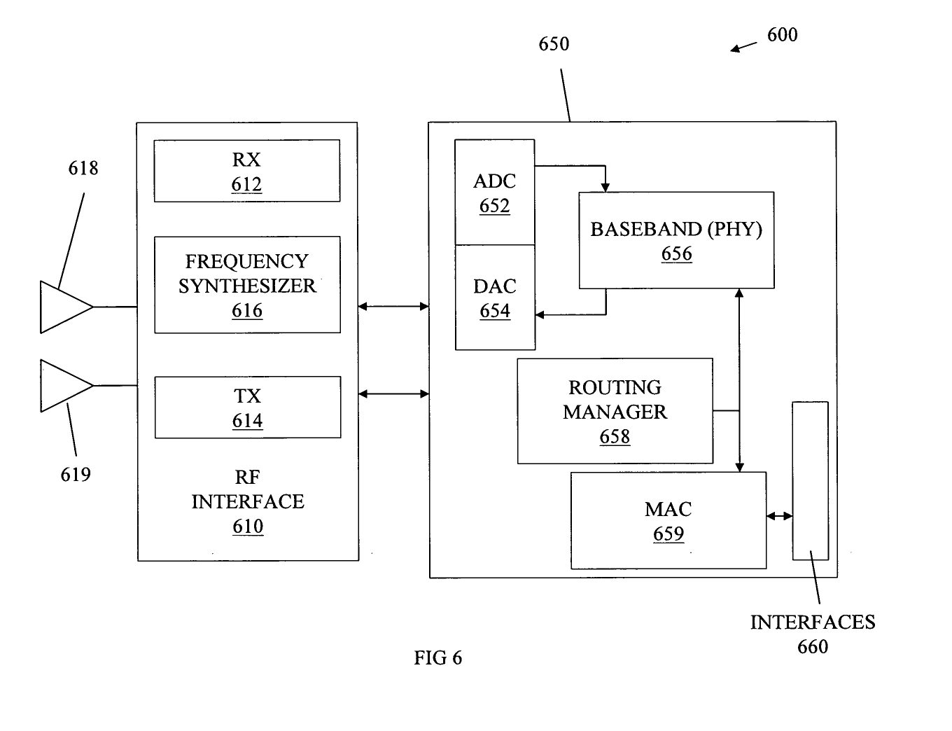

FIG. 6 depicts a block diagram showing an example wireless apparatus according to various embodiments. Apparatus 600 for use in a wireless network may include a processing circuit 650 including logic (e.g., circuitry, processor(s) and software, or combination thereof) to route communications as described in one or more of the processes above. In certain embodiments, apparatus 600 may generally include a radio frequency (RF) interface 610 and a baseband and MAC processor portion within the processing circuit 650.

In one example embodiment, RF interface 610 may be any component or combination of components adapted to send and receive modulated signals (e.g., OFDM) although the inventive embodiments are not limited to any particular modulation scheme. RF interface 610 may include, for example, a receiver 612, a transmitter 614 and a frequency synthesizer 616. RF interface 610 may also include bias controls, a crystal oscillator and/or one or more antennas 618, 619 if desired. Furthermore, RF interface 610 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description for configuration thereof is therefore omitted. In some embodiments RF interface 610 may be configured to provide OTA link access which is compatible with one or more of the IEEE standards for WPANs, WLANs, WMANs or WWANs, although the embodiments are not limited in this respect.

Processing circuit 650 may communicate/cooperate with RF interface 610 to process receive/transmit signals and may include, by way of example only, an analog-to-digital converter 652 for digitizing received signals, a digital-to-analog converter 654 for up converting signals for carrier wave transmission, and a baseband processor 656 for physical (PHY) link layer processing of respective receive/transmit signals. Processing circuit 650 may also include or be comprised of a processing circuit 659 for MAC/data link layer processing.

In certain embodiments of the present invention, a mesh routing manager 658 may be included in processing circuit 650 and which may function to determine routing and control mesh node addressing as described previously. Alternatively or in addition, PHY circuit 656 or MAC processor 659 may share processing for certain of these functions or perform these processes independently. MAC and PHY processing may also be integrated into a single circuit if desired.

Apparatus 600 may be, for example, a mobile station, a wireless base station or AP, a hybrid coordinator (HC), a wireless router and/or a network adaptor for electronic devices. Accordingly, the previously described functions and/or specific configurations of apparatus 600 could be included or omitted as suitably desired.

Embodiments of apparatus 600 may be implemented using single input single output (SISO) architectures. However, as shown in FIG. 6, certain implementations may use multiple input multiple output (MIMO), multiple input single output (MISO) or single input multiple output (SIMO) architectures having multiple antennas (e.g., 518, 519) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of apparatus 600 may be implemented using any combination of discrete circuitry, application specific integrated circuits (ASICs), logic gates and/or single chip architectures. Further, the features of apparatus 600 may be implemented using microcontrollers, programmable logic arrays and/or microprocessors or any combination of the foregoing where suitably appropriate (collectively or individually referred to as “logic”).

It should be appreciated that the example apparatus 600 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The present invention and some of its advantages have been described in detail for some embodiments. It should be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. A method for communicating in a wireless network, comprising:
scheduling relay transmissions by stations in separate cells of the wireless network based on out-of-cell interference; and
transmitting data by one or more wireless nodes within the wireless network using orthogonal downlink frame formats and uplink frame formats that prevent a first station of a particular class from transmitting while a separate, second station of the particular class is listening.

2. The method of claim 1, wherein scheduling relay transmissions by stations in separate cells of the wireless network based on out-of-cell interference comprises scheduling relay transmissions based on a topology of stations of the wireless network.

3. The method of claim 2, wherein scheduling relay transmissions based on the topology of stations comprises scheduling topologically-similar relay stations in adjacent cells to transmit simultaneously to reduce interference levels caused by the relay stations.

4. The method of claim 1, wherein scheduling relay transmissions by stations in separate cells of the wireless network based on out-of-cell interference comprises scheduling relay transmissions based on signal-to-interference ratios between stations of the wireless network.

5. The method of claim 4, wherein scheduling relay transmissions based on signal-to-interference ratios between stations of the wireless network comprises dynamically rescheduling relay transmissions based on measured signal-to-interference ratios.

6. The method of claim 4, wherein the signal-to-interference ratios are estimated signal-to-interference rations.

7. The method of claim 1, wherein the downlink frame format comprises base station transmission capacity and relay station transmission capacity, and wherein further the uplink frame format comprises mobile station transmission capacity and relay station transmission capacity.

8. A wireless device, comprising:
a processing circuit including logic to schedule relay transmissions by stations in separate cells of a wireless network based on out-of-cell interference and to allocate communication resources between orthogonal downlink and uplink frame formats to prevent a first station of a particular class from transmitting while a second station of the particular class is listening.

9. The wireless device of claim 8, further comprising a radio frequency (RF) interface communicatively coupled to the processing circuit and at least one antenna coupled to the RF interface.

10. The wireless device of claim 8, wherein the logic schedules relay transmissions by stations in separate cells based on a topology of stations of the wireless network.

11. The wireless device of claim 8, wherein the logic schedules relay transmissions by stations in separate cells based on signal-to-interference ratios (SIRs) between stations of the wireless network.

12. The wireless device of claim 8, wherein the wireless device comprises one of a base station, a relay station, or a mobile station.

13. A wireless system, comprising:
a processing circuit including logic to schedule relay transmissions by stations in separate cells of a wireless network based on out-of-cell interference and to allocate communication resources between orthogonal downlink and uplink frame formats to prevent a first station of a particular class from transmitting while a second station of the particular class is listening;
a radio frequency (RF) interface communicatively coupled to the processing circuit; and
at least one antenna coupled to the RF interface.

14. The wireless system of claim 13, wherein the logic schedules relay transmissions by stations in separate cells based on a topology of stations of the wireless network.

15. The wireless system of claim 13, wherein the logic schedules relay transmissions by stations in separate cells based on signal-to-interference ratios (SIRs) between stations of the wireless network.
